(19) United States
(12) Patent Application Publication
(10) Pub. No.: US 2014/0124141 A1
(43) Pub. Date: May 8, 2014

(54) LAMINATOR

(71) Applicant: Bernd Loibl, Klettgau (DE)

(72) Inventor: Bernd Loibl, Klettgau (DE)

(73) Assignee: MONOLITH GmbH, Essen (DE)

(21) Appl. No.: 13/853,257

(22) Filed: Mar. 29, 2013

(30) Foreign Application Priority Data
May 9, 2012 (DE) 202012101706.7

(51) Int. Cl. B32B 41/00

(52) U.S. Cl. CPC B32B 41/00
USPC 156/378

(57) ABSTRACT

A laminator for hot laminating a combination of sheet material and a laminating foil, the laminator including a housing; a pass-through channel extending in the housing for passing a combination of sheet material and laminating foil through; a laminating device arranged in the housing, wherein the laminating device includes a heating device, wherein the combination is laminated in the laminating device under pressure and heat, wherein the heating device includes a temperature display device which includes a display element which generates an externally detectable display when the heating device has reached a ready temperature that corresponds to an operational readiness of a laminator, and wherein the display element is configured as at least one reversible thermo-chromic element which is operatively coupled with the heating device so that a reversible discoloration of the at least thermo-chromic element occurs as a function of the temperature of the heating device.

### RELATED APPLICATIONS

This application claims priority from and incorporates by reference German utility model application 20 2012 101 706.7, filed on May 9, 2012 which is incorporated by this reference in its entirety.

### FIELD OF THE INVENTION

The invention relates to a laminator for hot laminating a combination made from a sheet material and a laminating foil, including a housing through which a pass-through channel extends for passing through the combination and in which a laminating device associated with the pass-through channel is arranged in which laminating device the combination is laminatable under pressure and heat and which includes a heater for heating the laminating foil, wherein the heater is provided with a temperature display device which includes a display element which generates an externally visible display when a ready temperature has been reached in the heater, which corresponds to readiness of the laminator for operations.

### BACKGROUND OF THE INVENTION

In order to protect sheet material, in particular valuable documents, it is known to weld the sheet material together with a laminating foil. For this purpose, the sheet material is welded between two foil sheets forming the laminating foil. These can be individual foil sheets or foil webs which are separated by cutting devices. Instead, the two foil sheets can also be provided in the form of a laminating pouch, in which the two foil sheets are connected with one another at least at one side edge. Such laminating foils are known for example from DE 197 44 595 A1 and DE 201 00 328 U1. The foil sheets are configured as composite foils in which a transparent clear foil, for example made from polyethylene or polypropylene is provided with a heat sensitive glue layer which is made for example from EVA (Ethylene-Vinylacetate-Copolymer) (c.f. DE 600 29 505 T2).

Laminating sheet material with laminating foils of this type is performed in the non-industrial field, this means in office and personal applications with laminators typically provided as table top units. Such laminators are known for example from DE 20 2005 005 020 U1 and EP 2 329 950 A1. They have essentially identical configurations, this means a housing in which a laminating device is arranged. Between an inlet opening on one side and an outlet opening on the other side of the housing, a pass-through channel extends through the housing, wherein the laminating device in the interior of the housing is associated with the pass-through channel. The laminating device typically includes at least one pair of rollers, sometimes also plural pairs of rollers, including two respective laminating rollers arranged on top of one another and leaving a laminating gap open there between. The laminating gap between two opposite laminating rollers is adjusted so that the combination from sheet material and laminating foil in the laminating gap is subjected to substantial pressure.

In hot laminators at least one of the laminating rollers, typically both laminating rollers are provided with a heater so that the combination of sheet material and laminating foil is additionally heated. Thus, the heat sensitive glue layers melt, become gluing capable which glues the laminating foil together with the sheet material to be welded.

In order to achieve safe melting of the glue layers and thus a reliable lamination of the sheet material, the heater of the laminating device must reach a particular temperature, namely the ready temperature. After switching the cold laminator on, it takes a while and the laminator should not be used yet during this time period in order to prevent faulty laminations. In order to indicate to the user that the laminator is ready to operate, thus the heater has reached the ready temperature, laminators of this type include temperature display devices which include a sensor for detecting the temperature of the heater and a display device with an externally detectable display element.

In the known laminators, the temperature display device is an electronic unit that is provided with a heat sensitive sensor, a control device and an electrically controllable illuminant which is arranged at an outside of the housing. The illuminant is lit up or is turned off as soon as the sensor determines that the heater has reached the ready temperature. Then the laminator can be operated.

The temperature display devices described supra have a complex configurations requiring complex assembly and are prone to malfunction.

### BRIEF SUMMARY OF THE INVENTION

Thus, it is an object of the invention to provide a laminator with a temperature display device which is configured much simpler and more economically and which has high reliability.

The object is achieved through a laminator for hot laminating a combination of sheet material and a laminating foil, the laminator including a housing; a pass-through channel extending in the housing for passing a combination of sheet material and laminating foil through; a laminating device arranged in the housing and associated with the pass-through channel, wherein the laminating device includes a heating device, wherein the combination of sheet material and laminating foil is laminated in the laminating device under pressure and heat, wherein the heating device includes a temperature display device which includes a display element which generates an externally detectable display when the heating device has reached a ready temperature that corresponds to an operational readiness of a laminator, and wherein the display element is configured as at least one reversible thermo-chromic element which is operatively coupled with the heating device so that a reversible discoloration of the at least thermo-chromic element occurs as a function of the temperature of the heating device.

This object is achieved according to the invention in that the display element is configured as at least one reversible thermo-chromic element which is operatively coupled with the heating device so that a reversible color change of the element occurs as a function of the temperature of the heating device. Thus, it is a basic idea of the invention to use a passive element configured as a reversible thermo-chromic element for the display element. Such thermo-chromic elements change colors as a function of a temperature that they are subjected to without requiring additional essential devices. The thermo-chromic element thus performs the function of a sensor and also the function of a display element itself. In order for the thermo-chromic element to function, non-active elements like power supply, etc., are required. Therefore, there is no risk of failure. Due to the simple configuration of the temperature display device, the cost for production and assembly is low. The user only has to watch whether the thermo-chromic element has reached a particular color before he starts using the laminator for a laminating process.

Thermo-chromic elements have been known for quite a while. The color changes of such elements associated with temperature changes are based on changes of the molecule- or crystal structure. It is known to use inorganic compounds like rutile and zinc-oxide for this purpose. However, there are also organic compounds. Examples can be derived from DE 10 2008 011 444 A1 and DE 103 39 442 A1. The thermo-chromic element can be configured in particular in the form of a flat element, for example as a foil or as a lacquer applied to an outside of a carrier. Thus, the thermo-chromic element can have the property to continuously change its color with increasing temperature or also to provide a defined color change in the range of the operating temperature.

In an advantageous embodiment of the invention, it is provided that the heater is configured at least as one heating roller, thus preferably as a pair of heating rollers between which a gap that forms the pass-through channel is left open. This does not exclude that also heating rods or heating plates that are mounted at the laminator can be used instead of a heating roller in order to heat the combination of laminating foil and sheet material.

The display device can be arranged in the heat radiation portion of the heater so that it is loaded with the heat radiation originating from the heater and so that the display device is heated up so that the thermo-chromic element changes colors with temperature towards a final color. The thermo-chromic element can be essentially arranged above the heater device at the top side of the housing, so that the distance between the heating device and the thermo-chromic element is short and the color change can be easily observed by the user of the laminator.

In another embodiment of the invention it is provided that at least one color comparison field is arranged adjacent to the thermo-chromic element, wherein the color of the color comparison field corresponds to the color which is assumed by the thermo-chromic element when reaching the operating temperature of the laminator. Through a color comparison field, it is easy to determine for the user whether the thermo-chromic element has reached the color that corresponds to readiness for operations or the ready temperature. This is determinable for an eye of a user in a particularly simple manner when the color comparison field is directly adjacent to the thermo-chromic element, thus advantageously so that the color comparison field and the thermo-chromic element are not distinguishable anymore when the thermo-chromic element has reached the color that corresponds to the ready temperature.

The color comparison field can be arranged in different ways. For example, the color comparison field can surround the thermo-chromic element. When the thermo-chromic element is configured as a flat element, the color comparison field can be arranged at least partially within the boundaries of the thermo-chromic element. Both configurations can also be combined with one another. Furthermore, there is the option that the thermo-chromic element is arranged below the at least one color comparison field which is respectively provided with at least one pass-through opening for visual access to the thermo-chromic element. Also in this respect, a combination with differently arranged color comparison fields can be performed.

According to another feature of the invention it is provided that the thermo-chromic element contacts a metal heat conducting element which reaches into the heat radiating portion of the heater device. The metal employed should have high heat conductivity like for example copper or a metal with similar heat conductivity. Through the heat conducting element, the distance between the heater device and the thermo-chromic element can be partially bridged and thus the heat loading of the thermo-chromic element can be intensified. Thus, the heat conducting element can also be configured so that it provides a heat radiation shade for the thermo-chromic element so that the thermo-chromic element is only loaded with heat which is transferred through the heat conducting element. Preferably, the thermo-chromic element should essentially be in contact with the heat conductive element in its entirety, so that it has even color distribution over its surface.

The heat conducting element can have heat conducting sections on both sides of the thermo-chromic element, wherein the heat conducting sections extend in a direction towards the heating device. Advantageously, the heat conducting sections should be connected with one another through a connection section at their ends adjacent to the heating device. The thermo-chromic element can be arranged in a display support which is inserted into the housing, preferably clipped into the housing. This facilitates assembly of the display device and thus of the thermo-chromic element.

Furthermore, it is within the scope of the invention to also provide plural thermo-chromic elements and/or heat conductive elements, and/or to combine the thermo-chromic elements with plural color comparison fields.

### BRIEF DESCRIPTION OF THE DRAWINGS

The invention is described in more detail based on an embodiment with reference to drawing figures, wherein:

FIG. 1 illustrates a vertical sectional view through the laminator according to the invention;

FIG. 2 illustrates a top view of the laminator according to FIG. 1;

FIG. 3 illustrates the temperature display device of the laminator according to FIGS. 1 and 2;

FIG. 4 illustrates the temperature display device according to FIG. 3 before the thermo-chromic surface element is inserted and without the heat conductive element; and

FIG. 5 illustrates the heat conducting element for the temperature display device according to FIG. 3.

### DETAILED DESCRIPTION OF THE INVENTION

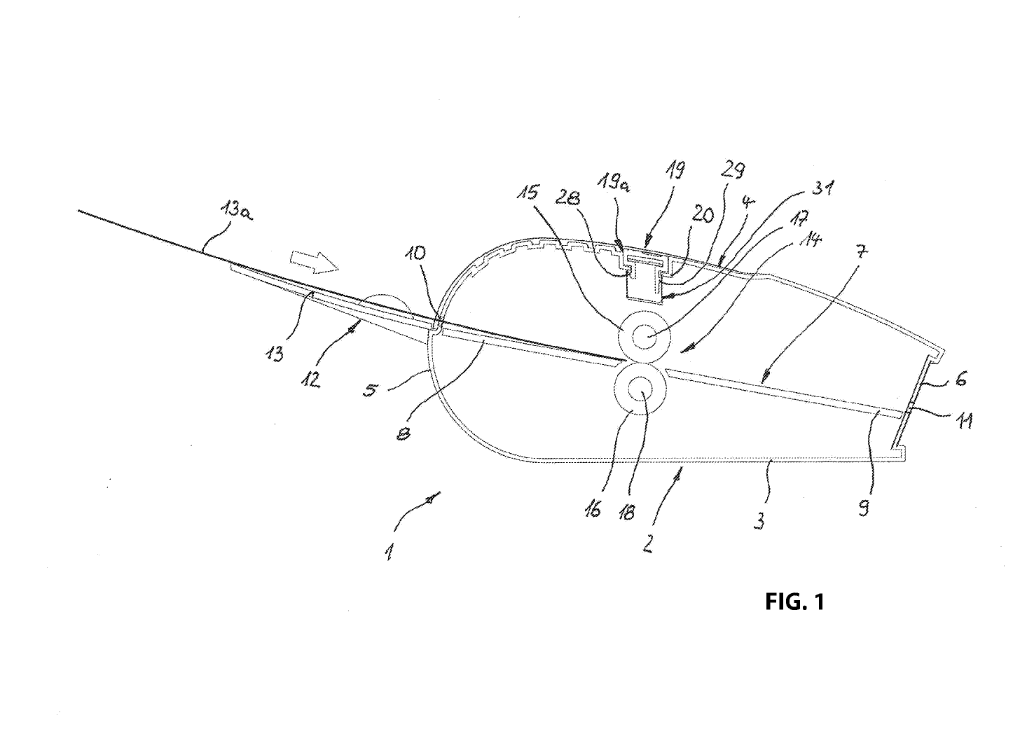

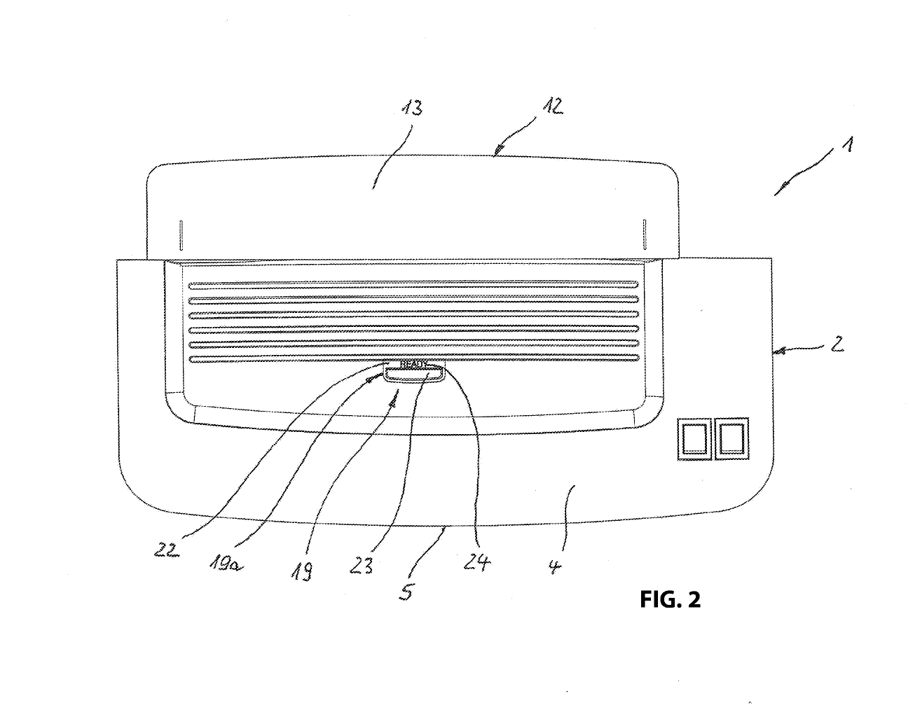

The laminator 1 illustrated in FIGS. 1 and 2 includes a housing 2 with a flat housing base 3, an upper wall 4 and front- and back walls 5, 6 connecting the housing base and the upper wall, wherein the front wall 5 connects the housing base 3 and the upper wall 4 in an arcuate shape. A slightly downward sloping pass-through channel 7 extends from the front wall 5 to the back wall 6, wherein the bottom side of the pass-through channel is formed by contact plates 8, 9 attached at the laminator. The pass-through channel 7 is defined on the front side by the supply opening 10 in the front wall 5 and defined on the backside by an outlet opening 11 in the rear wall 6.

A sheet support 12 is mounted at the front wall 5, wherein the top side 13 of the sheet support joins flush at the bottom edge of the supply opening 10 and at the support plate 8. In FIG. 1, the sheet support supports a combination 13a of laminating foil and sheet material on a top side of the sheet support, wherein the front edge of the combination is arranged approximately at the level of the front edge of the support plate 8.

A laminating device 14 is arranged approximately in the center of the pass-through channel 7 between the defining edges of the support plates 8, 9, wherein the defining edges are oriented towards one another. From this laminating device 14, two cylindrical laminating rollers 15, 16 are visible that are arranged on top of one another and with their rotation axes oriented parallel to one another. The laminating rollers 15, 16 extend over the entire width of the pass-through channel 7 and form a non-visible laminating gap between one another, wherein the laminating gap is invisible due to its small dimensions. The laminating rollers 15, 16 include coaxially extending heating rods 17, 18 which are configured as electrical resistive heating rods. They are configured and controlled as required so that they have a particular defined temperature when the laminator 1 is ready to be operated. This temperature can be between 80° C. and 140° C. The laminating device 14 includes a drive with an electric motor which is not illustrated in more detail, which drives the two laminating rollers 15, 16 synchronously, thus the upper laminating roller 15 counterclockwise and the lower laminating roller 16 clockwise. Their circumferential velocities are identical.

A temperature display device 19 with a display element 19a configured as a molded plastic component is integrated into the upper wall 4 above the laminating rollers 15, 16. Thus, a recess 20 is molded into the upper wall 4, wherein a slot is left open in the base of the recess. The temperature display device 19 is inserted into the recess 20, so that its top side terminates flush with the top side of the upper wall.

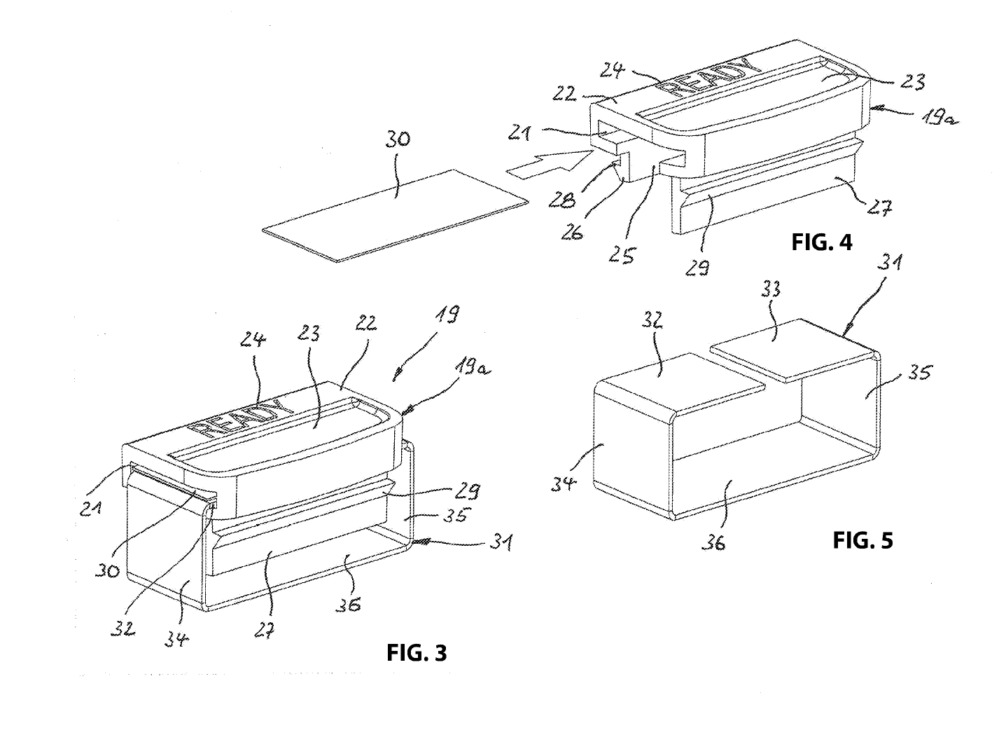

As evident from FIGS. 3 and 4, the display element 19a includes a slot 21 that extends essentially horizontally. The slot 21 is defined on the top side by a housing wall 22 which includes a transparent window 23 and adjacent thereto cutouts configured as lettering for the word “READY” 24. The slot 21 includes a continuous longitudinal opening 25 at its bottom, wherein downward oriented support bars 26, 27 extend from the defining edges. The support bars 26, 27 are provided with engagement protrusions 28, 29 at sides oriented away from one another, wherein the engagement protrusions reach below the bottom sides of the recess 20 in installed condition (c.f. FIG. 1). This way, the temperature display device 19 can be inserted from above into the recess 20 and can be interlocked therewith.

A thermo-chromic surface element 30 configured as a display element with rectangular cross-section is included in the temperature display device 19, wherein the surface element is configured as a foil and has reversible thermo-chromic properties. As illustrated in FIG. 4, the thermo-chromic surface element 30 is inserted into the slot 21 before mounting the temperature display device 19 until the thermo-chromic surface element has the position illustrated in FIG. 3. In this position, the thermo-chromic surface element 30 extends over the window 23 and also over the lettering “READY” 24. The thermo-chromic surface element 30 has a width so that it is supported within the slot 21.

A heat conducting element 31 is also associated with the temperature display device 19, wherein the heat conducting element is configured as a clamp as illustrated in particular in FIG. 5 and is made from copper or a copper alloy in order to obtain high heat conductivity. The heat conducting element 31 has two support arms 32, 33 which protrude in mounted condition (c.f. FIG. 3) from the open sides of the slot 21 into the slot 21 and essentially have the width of the thermo-chromic surface element 30. They only have a small distance at the edges oriented towards one another. The thermo-chromic surface element 30 directly contacts with the support arms 32, 33 (c.f. FIG. 3), so that a heat conducting contact is provided with the entire surface.

Heat conducting sections 34, 35 extend perpendicular from edges of the support arms 32, 33 oriented away from one another. As apparent from FIG. 1, the heat conducting sections 34, 35 reach close to the upper laminating roller 15. At this location, the heat conducting sections 34, 35 are connected by a connecting section 36 which extends parallel to the support arms 32, 33.

For a cold laminator 1, the thermo-chromic surface element 30 has a particular color which provides information to the user of the laminator 1 that the unit is not at operating temperature and thus not ready to operate. The color of the thermo-chromic surface element 30 can be observed by the user through the window 23 and the lettering “READY” 24. When the laminator 1 is turned on, the heating rods 17 are loaded with electrical power, so that the laminating rollers 15, 16 heat up. The heat radiation emitted in particular by the upper laminating roller 15 is absorbed by the connecting section 36 of the heat conducting element 31 and leads to its respective heat up. Due to heat conduction, also the heat conducting sections 34, 35 and eventually the support arms 32, 33 heat up. Their heat is transmitted to the thermo-chromic surface element 30. Due to their thermo-chromic properties, it changes its color as a function of the temperature which can be observed by the user of the laminator 1 through the window 23 and the letter 24. The color change can also include an intensity change of a particular color.

When reaching the predetermined operating temperature of the laminating rollers 15, 16, the thermo-chromic surface element 30 assumes a predetermined coloration which indicates to the user that he can now start operating the laminator 1 to perform a lamination process. In order to provide assistance to the user for a determination of the color in which the thermo-chromic element 30 assumes the color indicating readiness for operations, the top side of the housing wall 22 is configured with this color forming a color comparison field or colored in this manner. When this color coincides with the color of the thermo-chromic surface element 30, then it is apparent for the user that he can start a laminating process. For this purpose he places the combination 13a as illustrated in FIG. 1 onto the sheet support 12 and inserts it into the pass-through channel 7 until it is picked up by the driven laminating rollers 14, 15. The combination 13 is then transported through the laminating gap where it is subjected to pressure and heat over its entire surface. Thereafter, the laminated combination 13a can be removed through the outlet opening 11.

What is claimed is:

1. A laminator for hot laminating a combination of sheet material and a laminating foil, the laminator including:
a housing;
a pass-through channel extending in the housing for passing a combination of sheet material and laminating foil through;
a laminating device arranged in the housing and associated with the pass-through channel,
wherein the laminating device includes a heating device,
wherein the combination of sheet material and laminating foil is laminated in the laminating device under pressure and heat,
wherein the heating device includes a temperature display device which includes a display element which generates an externally detectable display when the heating device has reached a ready temperature that corresponds to an operational readiness of a laminator, and
wherein the display element is configured as at least one reversible thermo-chromic element which is operatively coupled with the heating device so that a reversible discoloration of the at least thermo-chromic element occurs as a function of the temperature of the heating device.

2. The laminator according to claim 1, wherein the heating device is configured as at least one heating roller.

3. The laminator according to claim 1, wherein the temperature display device is arranged in a heat radiation portion of the heating device.

4. The laminator according to claim 1, wherein the thermo-chromic element is arranged substantially above the heating device at a top side of the housing.

5. The laminator according to claim 1 4,
wherein at least one color comparison field is arranged adjacent to the thermo-chromic element,
wherein a color of the at least one color comparison field corresponds to a color to which is assumed by the thermo-chromic element when a ready temperature of the laminator is reached.

6. The laminator according to claim 5, wherein the at least one color comparison field envelops the thermo-chromic element.

7. The laminator according to claim 5, wherein the thermo-chromic element is a flat element and the at least one color comparison field is at least partially arranged within boundaries of the thermo-chromic element.

8. The laminator according to claim 1, wherein the thermo-chromic element is arranged below the at least one color comparison field which is provided with at least one pass-through for rendering the thermo-chromic element visible.

9. The laminator according to claim 1, wherein the thermo-chromic element contacts a metal heat conducting element which reaches into a heat radiation portion of the heating device.

10. The laminator according to claim 9, wherein the heat conducting element is configured so that it puts a heat radiation shade onto the thermo-chromic element.

11. The laminator according to claim 9, wherein the thermo-chromic element contacts the heat conducting element at least substantially in its entirety.

12. The laminator according to claim 11,
wherein the heat conducting element includes heat conducting sections on both sides of the thermo-chromic element,
wherein the heat conducting sections extend in a direction towards the heating device.

13. The laminator according to claim 12, wherein the heat conducting sections are connected with one another at ends adjacent to the heating device through a connecting section.

14. The laminator according to claim 1, wherein the thermo-chromic element is arranged in a display support which is snap locked into the housing.
